(19) United States
(12) Patent Application Publication
(10) Pub. No.: US 2005/0231155 A1
(43) Pub. Date: Oct. 20, 2005

(54) Battery pack with power input/output

(76) Inventor: Yu-Huei Huang, Chungho City (TW)

Correspondence Address: Dougherty & Troxell;ONE SKYLINE PLACE, SUITE 600, 5205 LEESBURG PIKE, FALLS CHURCH, VA, 22041, US

(21) Appl. No.: 10/852,176

(22) Filed: May 25, 2004

(30) Foreign Application Priority Data
Apr. 19, 2004 (TW) 093206004

(51) Int. Cl. H02J 7/00

(52) U.S. Cl. 320/107

(57) ABSTRACT

A battery pack with power input/output comprising a pack pedestal, a pack cover, an electrode connector set, a power output terminal and a power input terminal. A pack chamber is between the front wall and the electrode connectors, the pack chamber further comprises a control switch, an output terminal and the input terminal, the input/output terminal connect to the control switch, the control switch decides whether to output power with batteries inside or other external power sources.

### BACKGROUND OF THE INVENTION

I. Field of the Invention

The present invention relates to a battery pack, and particularly, to a battery pack with power input/output functions.

II. Description of the Prior Art

The dry batteries have experienced longstanding development and so have battery packs that hold batteries. Battery packs are mostly integrated with electric appliances such as toys, palm-top radios and flashlights, and some of them are standalone type. Another type is battery pack for chargeable batteries wherein after nickel-cadmium battery is in place, the battery pack is inserted into AC socket and charges nickel-cadmium battery.

The greatest feature for these battery packs is that most of them adopt series circuits. This is probably attributable to the voltage requirements. A conventional battery pack usually comprises two batteries in parallel but adopts series circuits.

To overcome such disadvantages as liquid infiltration, improper battery positioning and infirm connection, the applicant of the present invention has made some improvements on conventional battery packs and invented “enclosed battery holder” that won Taiwan Utility Model No. 103972 (corresponding to U.S. Pat. No. 5,537,022). For personal electronic products such as mobile phone and personal digital assistant (PDA) application, when users are at a place where it is impossible to charge exhausted batteries (usually with special structure or size), such electronic products will stay useless. To address this bottleneck, the applicant of the present invention hereby proposes the supplementary application for the above patent (corresponding to U.S. patent application Ser. No. 09/934,532).

### SUMMARY OF THE INVENTION

It is therefore a primary object of the invention to provide a battery pack that offers more convenience to users; users can carry the sealed battery pack around as a power supply, when other power sources are available, the battery pack can connect to the other power sources to avoid the consumption of the batteries power inside the battery pack.

In order to achieve the objective set forth, a battery pack in accordance with the present invention comprises a pack pedestal with open top, two ladder-shape pack ribs are on the top of the pack walls, the ends of two pack walls are respectively connected to a front wall and a rear wall to separate the batteries, at least one fastening tenon and at least one fastening hole are on the front wall and rear wall, at least one parting slip is on the pack walls, a pack tenon and a parting tenon are provided at a proper location between the pack walls and the parting slips for the relay electrode connectors, the negative electrode connectors and the positive electrode connectors to form series for parallel connection; a pack cover is a cover body with a cover rib, a cover groove and a fastening hook corresponding to the pack rib, the fastening tenon and the fastening hole respectively to make the pack cover slide on the pack pedestal after connection, the cover groove embeds with the fastening tenon, the fastening hook wedges with the fastening hole; a pack chamber is between the front wall and the electrode connectors, the pack chamber further comprises a control switch, an output terminal and the input terminal, the input/output terminal connect to the control switch, the control switch decides whether to output power with batteries inside or other external power sources.

### BRIEF DESCRIPTION OF THE DRAWINGS

The accomplishment of the above-mentioned object of the present invention will become apparent from the following description and its accompanying drawings which disclose illustrative an embodiment of the present invention, and are as follows:

FIG. 1 is an assembly view of the present invention;

FIG. 2 is a perspective view the present invention;

FIG. 3 is a block diagram of the present invention; and

FIG. 4 is an application view of the present invention.

### DESCRIPTION OF THE PREFERRED EMBODIMENT

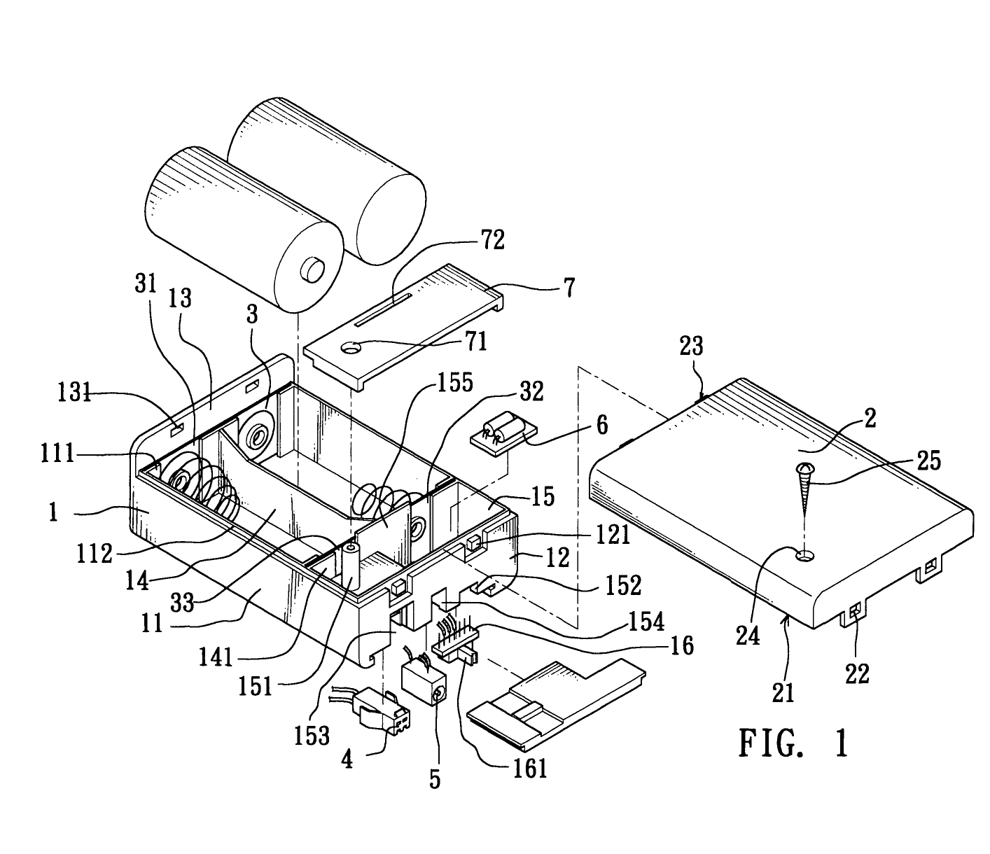

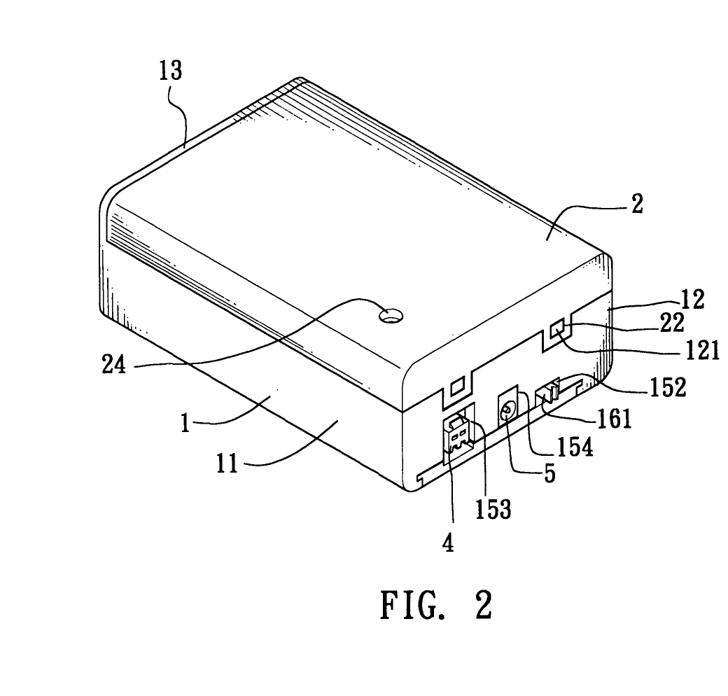

Referring to FIGS. 1 to 4, the present invention comprises a pack pedestal 1, a pack cover 2, an electrode connector set 3, an output terminal 4 and an input terminal 5. The function of each component is described as following:

The pack pedestal 1 is a semi-enclosed shell body; the ends of two pack walls 11 are respectively connected to a front wall 12 and a rear wall 13 to separate the batteries; at least one parting slip 14 is provided between two pack walls 11 to separate batteries from each other. In order to embed the electrode connector assembly 3 in the pack pedestal 1, a pack tenon 111 and a parting tenon 141 are provided at a proper location between the pack walls 11 and the parting slips 14 for the purpose of providing at least one relay electrode connector 31, one negative electrode connector 32 and one positive electrode connector 33. In addition, a ladder-shape pack rib 112 is provided on top of pack walls 11 such that the pack cover 2 may be connected and slide conveniently.

A pack chamber 15 is provided between the front wall 12 and the electrode connectors 3, a parting post 151 is provided in the pack chamber 15 to lock the pack cover 2. Furthermore, a button 161 on the control switch 16 extends out from the button hole 152 on the pack pedestal 1 such that when users press the button 161 to switch power on or off. An output hole 153 and an input hole 154 are provided at proper location in the pack chamber 15 to hold and the extend output terminal 4 and the input terminal 5. In addition, at least one fastening tenon 121 and one fastening hole 131 are provided on the front wall 12 and the rear wall 13 such that the pack cover 2 is fastened on two directions.

The pack cover 2 is a cover body enclosed on four sides and has a cover rib 21 at a location corresponding to the pack rib 112 such that the pack cover 2 may slide after connected with the pack pedestal 1. A cover groove 22 is provided at the front section of pack cover 2 corresponding to the position of the fastening tenons 121 to embed each other. A fastening hook 23 is also provided at the position of the fastening hole 131, a cover hole 24 is provided at the location corresponding to the parting post 151 that a screw 25 can pass through and lock the parting post 151.

The electrode connector assembly 3 comprises the relay electrode connector 31, the negative electrode connector 32 and the positive electrode connector 33 inserted into the pack tenon 111 and the parting tenon 141 such that batteries may constitute a series circuit or parallel circuit. The electrode connector assembly 3 couples with the control switch 16 and the output terminal 4 such that the output terminal 4 can output or cut off power when is switched.

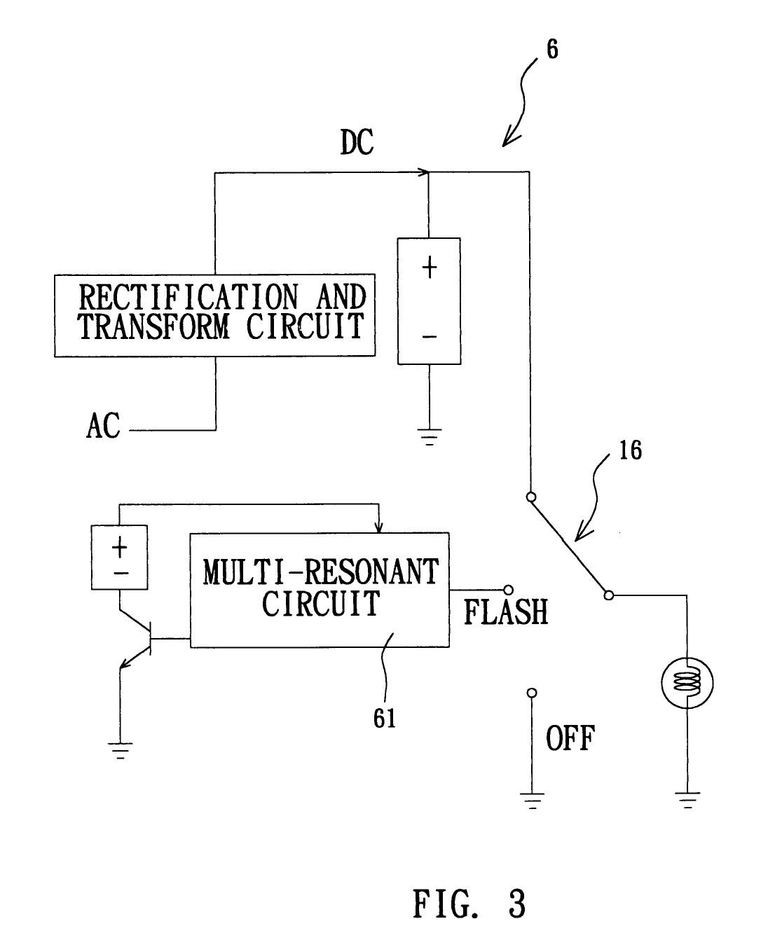

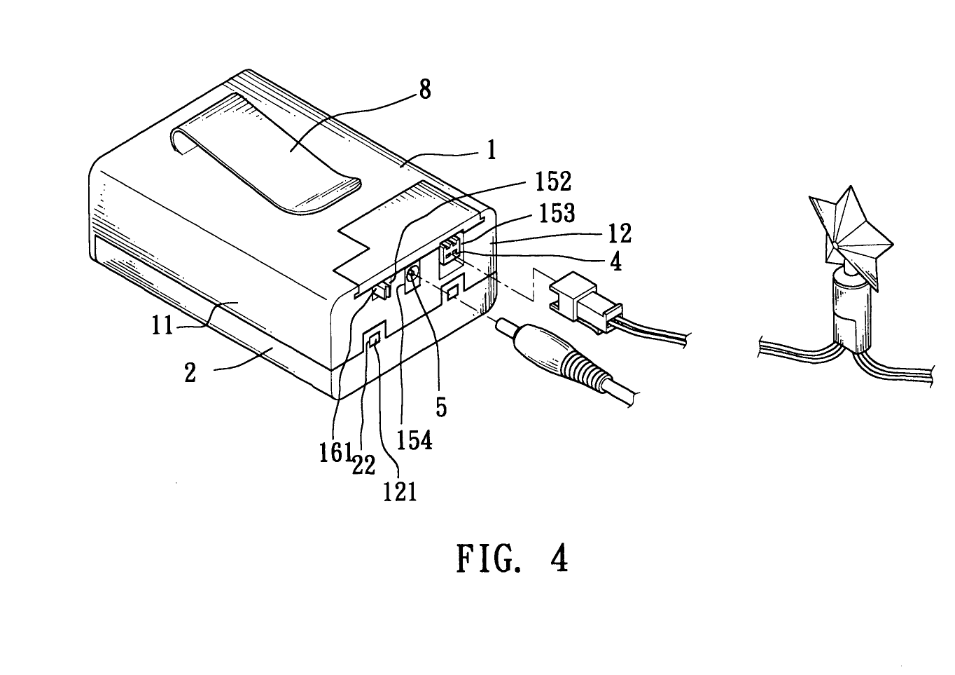

The output terminal 4 is coupled between the electrode connector assembly 3 and the control switch 16 and is located in the pack chamber 15 to be connected with lamp group on the electronic products, such as mobile phone via the output hole 153 (as shown in FIG. 4) to provide temporary power supply. Output terminal 4 serves as socket shown in drawings and when connected with corresponding plugs to supply power to electronic products; or output terminal 4 may serve as a plug to be connected with an input terminal (socket) on electronic products.

Wherein, a circuit board 6 is coupled between the output terminal 4 and the control switch 16 to serve as a function selector as shown in FIG. 3; the circuit board 6 comprises a multi-resonant circuit 61 to control the switch 16, the switch 16 controls power on/off and enables power to be connected intermittently such that the lamp set (FIG. 4) may go out, light up or flash, so such the lamp set may serve as decoration on human body or other objects such as Christmas tree.

The input terminal 5 is also located in the pack chamber 15 and can serve as socket or plug respectively coupled with the output terminal 4 and the control switch 16. In real application, where power supply is available, indoors, for example, the input terminal 4 is connected with power supply to enable lamp set to light up, go out or flash via control switch 16. As a result, the battery pack in the present invention can avoid battery consumption and has comprehensive functions suitable for both indoors and outdoors applications.

Furthermore, the circuit board 6 further comprises a charging circuit to charge batteries in the battery pack, the input terminal 5 can charge batteries via the charging circuit.

In addition, an inner cover 7 is provided to protect the components in the pack chamber 15; a through hole 71 is provided corresponding to the parting post 151, a hook groove 72 extending out from the pack chamber 15 corresponds to the pack hook 155 such that when the two parts are coupled, the inner cover 7 covers above the pack chamber 15.

To make the battery pack convenient to carry, a back clip 8 is integrated on the back of the pack pedestal 1 to provide clamping function.

Based on above description, the battery pack of the present invention can prevent liquid and dust and is firm and secure in the structure after assembling. As a result, the battery pack can supply power via batteries when no external power supply is available, or supply power via external power supply when available, thus achieving the effect of temporary power supply and continuous power supply. Therefore, the present invention represents a preferred structure compared with other similar products.

While a preferred embodiment of the invention has been shown and described in detail, it will be readily understood and appreciated that numerous omissions, changes and additions may be made without departing from the spirit and scope of the invention.

1. A battery pack comprising:
a pack pedestal with open top, two ladder-shape pack ribs are on the top of the pack walls, the ends of two said pack walls are respectively connected to a front wall and a rear wall to separate the batteries, at least one fastening tenon and at least one fastening hole are on said front wall and said rear wall, at least one parting slip is on said pack walls, a pack tenon and a parting tenon are provided at a proper location between said pack walls and said parting slips for the relay electrode connectors, the negative electrode connectors and the positive electrode connectors to form series for parallel connection;
a pack cover is a cover body with a cover rib, a cover groove and a fastening hook corresponding to said pack rib, said fastening tenon and said fastening hole respectively to make said pack cover slide on said pack pedestal after connection, said cover groove embeds with said fastening tenon, said fastening hook wedges with said fastening hole;
a pack chamber is between said front wall and said electrode connectors, said pack chamber further comprises a control switch, an output terminal and the input terminal, said input/output terminal connect to said control switch, said control switch decides whether to output power with batteries inside or other external power sources.

2. The battery pack recited in claim 1, wherein said input terminal and one side of said output terminal are plugs inside or stretching out from said pack pedestal.

3. The battery pack recited in claim 1, wherein said output terminal and one side of said output terminal are plugs inside or stretching out from said pack pedestal,

4. The battery pack recited in claim 3, wherein the shape of said plugs corresponds to the power inputs of the electronic products.

5. The battery pack recited in claim 1, wherein a parting post is provided in said pack chamber, a cover hole is in said pack cover at the location corresponding to said parting post that a screw can pass through and lock said parting post.

6. The battery pack recited in claim 1, wherein a circuit board 6 is coupled between said output terminal 4 and said control switch 16, said circuit board 6 comprises a multi-resonant circuit to controls power on/off and enables power to be connected intermittently.

7. The battery pack recited in claim 6, wherein said circuit board 6 further comprises a charging circuit to charge batteries, said input terminal can charge batteries via said charging circuit.

8. The battery pack recited in claim 1, wherein an inner cover is provided to protect the components in said pack chamber, a through hole is provided corresponding to said parting post, a hook groove extending out from said pack chamber corresponds to said pack hook such that when the two parts are coupled, said inner cover covers above said pack chamber.

9. The battery pack recited in claim 1, wherein a back clip is integrated on the back of said pack pedestal to provide clamping function.
